(19) United States
(12) Patent Application Publication
(10) Pub. No.: US 2007/0291369 A1
(43) Pub. Date: Dec. 20, 2007

(54) Optical element, lighting device, and liquid crystal display device

(76) Inventor: Takashi Shimura, Fujiyoshida-shi (JP)

Correspondence Address: BRINKS HOFER GILSON & LIONE, P.O. BOX 10395, CHICAGO, IL, 60610, US

(21) Appl. No.: 11/820,343

(22) Filed: Jun. 19, 2007

(30) Foreign Application Priority Data
Jun. 19, 2006 (JP) JP2006-169240

(51) Int. Cl. G02B 27/10

(52) U.S. Cl. 359/619

(57) ABSTRACT

A light-diffusing member made of an optically transparent material has a light-emitting surface that emits light while diffusing it. The light-emitting surface has a plurality of parallel elongated lens surfaces arranged side-by-side in a row thereon. The elongated lens surfaces each have a convexly arcuate cross-section. The height of the convexly arcuate cross-section of the elongated lens surfaces varies continuously and repeatedly in the longitudinal direction of the elongated lens surfaces.

This application claims priority under 35 U.S.C. §119 to Japanese Patent Application No. JP2006-169240 filed Jun. 19, 2006, the entire content of which is hereby incorporated by reference.

### BACKGROUND OF THE INVENTION

1. Field of the Invention

The present invention relates to an optical element, specifically, a light-diffusing member, for use in a lighting device of a passive (non-light-emitting in itself) display device such as a liquid crystal display device.

2. Description of the Related Art

FIG. 13a is a schematic sectional view showing an example of a structure of an assembly of a liquid crystal display device 28 and a lighting device 23 that illuminates the liquid crystal display device.

The liquid crystal display device 28 has upper and lower transparent substrates 36 provided with polarizers 32 and 34, respectively, and a liquid crystal layer 37 disposed between the upper and lower transparent substrates 36.

The lighting device (backlight unit) 23 has a light guide plate 22 that receives light from a light source 20 and that emits light from an upper surface thereof that faces a light-receiving surface of the liquid crystal display device 28. A reflector 26 is provided at a lower side of the light guide plate 22. A brightness enhancement film 29 is disposed at an upper side of the light guide plate 22 to direct light emitted from the light guide plate 22 perpendicularly to the light-receiving surface of the liquid crystal display device 28. A diffusing plate 30 is disposed at an upper side of the brightness enhancement film 29 to diffuse light that has passed through the brightness enhancement film 29. Thus, the brightness enhancement film 29 and the diffusing plate 30 transmit light from the light guide plate 22 to the liquid crystal display device 28 efficiently and uniformly.

FIG. 13b shows another assembly of a liquid crystal display device 28 and a lighting device 23 which is similar to those shown in FIG. 13a. In the assembly shown in FIG. 13b, however, a diffusing plate 30 is provided close to a light guide plate 22. Light diffused through the diffusing plate 30 is passed through two prism sheets 38 and 40 serving as brightness enhancement films, thereby being formed into light perpendicular to the light-receiving surface of the liquid crystal display device 28.

Regarding such a lighting device of a liquid crystal display device, it has been proposed using a lenticular lens sheet having a multiplicity of cylindrical concave surfaces arranged side-by-side in a row to efficiently direct light from a light guide plate toward a liquid crystal display device (see Japanese Patent Application Publication No. Hei 06-201904).

It has also been proposed using a lenticular lens sheet having a multiplicity of cylindrical convex surfaces arranged side-by-side in a row to provide uniform light for illuminating a liquid crystal display device (see Japanese Patent Application Publication No. Hei 09-145932).

It has also been proposed using a lenticular lens sheet having a multiplicity of cylindrical convex surfaces to reduce the number of prism sheets used as described above, thereby minimizing the cost of the lighting device (see Japanese Patent Application No. 2005-216030).

Although the use of lenticular lens sheets in lighting devices has been proposed as stated above, the lenticular lens sheets involve the following problems.

FIG. 15a shows a cylindrical convex lens segment 80, and FIG. 15b shows a lenticular lens sheet 82 having a multiplicity of cylindrical convex lens segments 80 as shown in FIG. 15a. FIG. 16 shows the behavior of light from a light source 84 when the light impinges on to the lenticular lens sheet 82. As will be understood from FIG. 16, light passing through the lenticular lens sheet 82 is diffused in a direction perpendicular to the longitudinal direction of each of the cylindrical convex lens segments 80 constituting the lenticular lens sheet 82 but not substantially diffused in a direction parallel to the longitudinal direction of each of the lens segments 80. That is, an image of the light source 84 is formed as denoted by reference numeral 86.

### SUMMARY OF THE INVENTION

The present invention has been made in view of the above-described circumstances. Accordingly, an object of the present invention is to provide an optical element that has a multiplicity of elongated lens surfaces with a convexly or concavely arcuate cross-section, as in the case of the above-described lenticular lens sheet, and that has diffusibility not only in a direction perpendicular to the longitudinal direction in each of the lens surfaces but also in a direction parallel thereto.

The present invention provides an optical element having a light-emitting surface that emits light while diffusing it. A plurality of parallel elongated lens surfaces are arranged side-by-side in a row on the light-emitting surface. The elongated lens surfaces each have an arcuate cross-section. The height of the curved cross-section of the elongated lens surfaces varies continuously and repeatedly in the longitudinal direction of the elongated lens surfaces.

It should be noted that the term “arcuate” as used in this specification includes convexly and concavely arcuate cross-sectional configurations. When the elongated lens surfaces have a concavely arcuate cross-section, the term “the height of the arcuate cross-section” means the depth of a groove defined by the cross-section.

In this optical element, unlike the above-described conventional lenticular lens sheet, the height of the arcuate cross-section of the elongated lens surfaces varies continuously and repeatedly in the longitudinal direction of the elongated lens surfaces. Therefore, light emitted from the light-emitting surface is diffused not only in a direction perpendicular to the longitudinal direction of the elongated lens surfaces but also in a direction parallel thereto.

Specifically, the elongated lens surfaces may be formed so that the height of the arcuate cross-section of each elongated lens surface varies sinusoidally in the longitudinal direction of the lens surface.

More specifically, the elongated lens surfaces may be arranged so that sinusoidal waves formed by each adjacent pair of the elongated lens surfaces differ from each other in at least one of phase, period, and amplitude.

The above-described optical element may have an opposite surface opposite to the light-emitting surface and have a sheet shape as a whole.

The optical element may be arranged as follows. The opposite surface has a plurality of parallel second elongated lens surfaces arranged side-by-side in a row on the opposite surface. The second elongated lens surfaces each have an arcuate cross-section and extend in a direction perpendicular to the longitudinal direction of the elongated lens surfaces on the light-emitting surface. The height of the arcuate cross-section of the second elongated lens surfaces varies continuously and repeatedly in the longitudinal direction of the second elongated lens surfaces.

The cross-section of each of the above-described elongated lens surfaces may be convexly or concavely arcuate.

In addition, the present invention provides a lighting device using the above-described optical element.

The lighting device may have a light guide plate, wherein the optical element is disposed at the light-emitting surface side of the light guide plate in parallel thereto.

The light guide plate and the optical element may be integrally molded together.

In addition, the present invention provides a liquid crystal display device having the lighting device.

In addition, the present invention provides an apparatus, e.g. a cellular phone, having the liquid crystal display device.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a perspective view schematically showing a light-diffusing sheet according to the present invention.

FIG. 2a is a sectional view taken along the line 2a-2a in FIG. 1.

FIG. 2b is a sectional view similar to FIG. 2a, showing a light-diffusing sheet according to another embodiment of the present invention.

FIG. 3a is a sectional view similar to FIG. 2a, showing a modification of the light-diffusing sheet according to the present invention.

FIG. 3b is a sectional view similar to FIG. 2a, showing another modification of the light-diffusing sheet according to the present invention.

FIG. 3c is a sectional view similar to FIG. 2a, showing still another modification of the light-diffusing sheet according to the present invention.

FIG. 3d is a sectional view similar to FIG. 2a, showing a further modification of the light-diffusing sheet according to the present invention.

FIG. 4 is a diagram showing the relationship between curved surfaces formed by four lens surfaces sequentially arranged on the light-diffusing sheet according to the present invention.

FIG. 5 is a diagram showing various pitches of varying height of curved surfaces formed by lens surfaces on the light-diffusing sheet according to the present invention.

FIG. 6 is a perspective view of a single lens element having an elongated lens surface according to the present invention.

FIG. 7 is a perspective view of a light-diffusing sheet formed by arranging side-by-side in a row a plurality of elongated lens elements as shown in FIG. 6.

FIG. 8a is a side view of the light-diffusing sheet shown in FIG. 7.

FIG. 8b is an end view of the light-diffusing sheet shown in FIG. 7.

FIG. 9 is a diagram showing examples of various pitches of sinusoidal lens surfaces on the light-diffusing sheet according to the present invention.

FIG. 10 is a diagram showing the way in which light is diffused by the light-diffusing sheet of the present invention.

FIG. 11a is a perspective view showing an example in which the light-diffusing sheet according to the present invention is applied to an edge-light type lighting device.

FIG. 11b is a perspective view showing another example in which the light-diffusing structure according to the present invention that is provided on the upper surface of a light guide plate is applied to an edge-light type lighting device.

FIG. 12a is a plan view of a light guide plate provided with a conventional lenticular lens sheet.

FIG. 12b is a plan view of a light guide plate provided with the light-diffusing structure according to the present invention.

FIG. 13a is a sectional view showing an example of a general structure including a liquid crystal display device and a backlight unit that illuminates the liquid crystal display device.

FIG. 13b is a sectional view showing another example of a general structure including a liquid crystal display device and a backlight unit that illuminates the liquid crystal display device.

FIG. 14 is a schematic view of an apparatus having a liquid crystal display device using a lighting device according to the present invention.

FIG. 15a is a perspective view showing a lens segment of a conventional lenticular lens sheet shown in FIG. 15b.

FIG. 15b is a perspective view of a conventional lenticular lens sheet.

FIG. 16 is a diagram showing the way in which light is diffused by the conventional lenticular lens sheet.

FIG. 17a is a perspective view showing another example in which the light-diffusing sheet according to the present invention is applied to an edge-light type lighting device.

FIG. 17b is a perspective view showing still another example in which the light-diffusing sheet according to the present invention is applied to an edge-light type lighting device.

FIG. 18 is a side view of a light-diffusing sheet according to another embodiment that has elongated lens surfaces provided on both upper and lower sides thereof.

FIG. 19a is a perspective view showing a further example in which the light-diffusing sheet according to the present invention is applied to an edge-light type lighting device.

FIG. 19b is a perspective view showing a still further example in which the light-diffusing sheet according to the present invention is applied to an edge-light type lighting device.

### DESCRIPTION OF THE PREFERRED EMBODIMENTS

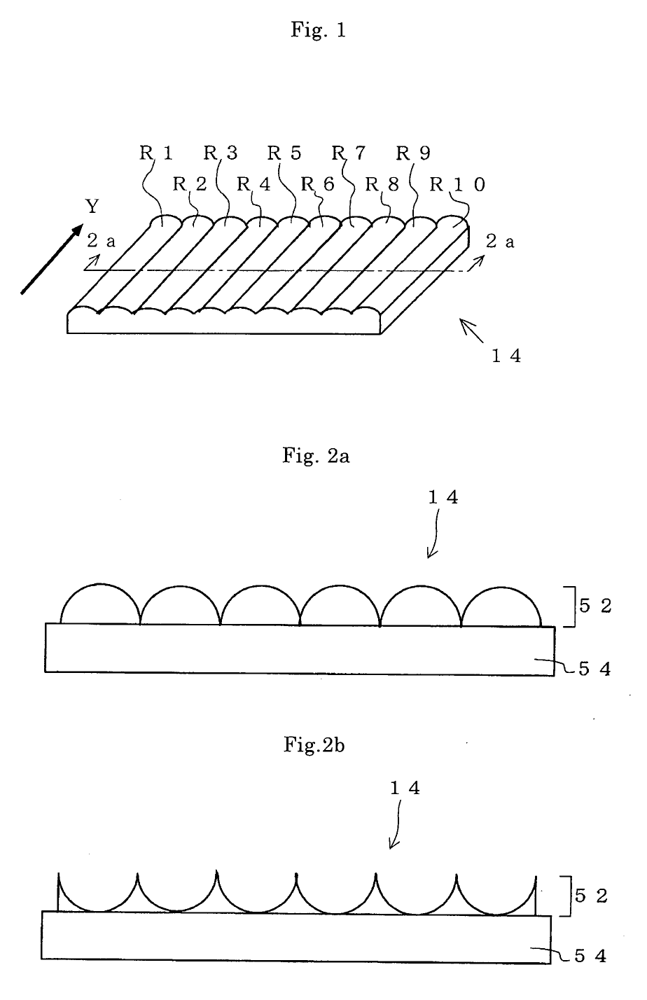

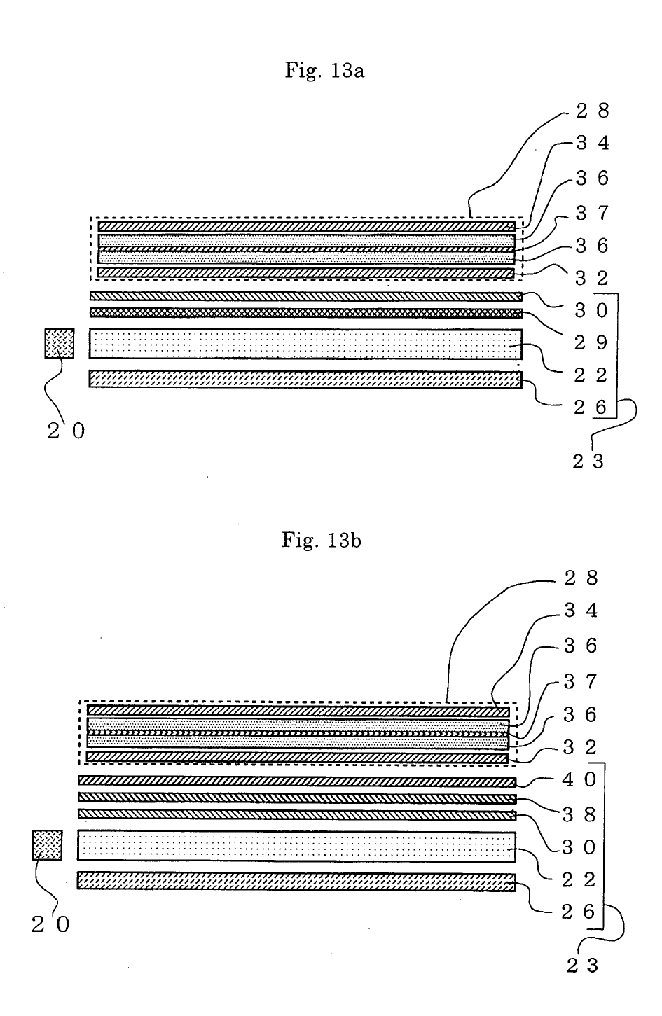

Embodiments of the present invention will be described below with reference to FIGS. 1 to 15b.

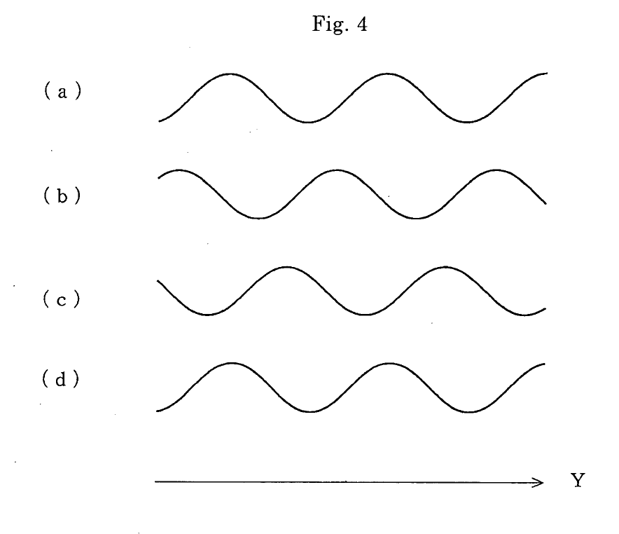

FIG. 1 shows schematically a light-diffusing sheet 14 as an optical element according to the present invention. The light-diffusing sheet 14 has a light-emitting surface formed by a row of side-by-side arranged elongated lens surfaces R1 to R10 having a convexly arcuate cross-section as shown in FIG. 2a, in the same way as the conventional lenticular lens sheet. Specifically, each elongated lens surface has, as shown in FIG. 4, a height periodically varying in the longitudinal direction Y thereof.

As shown in FIG. 2a, the light-diffusing sheet 14 comprises a sheet-shaped substrate 54 and a lens array 52 having elongated lens surfaces R1 to R10 formed thereon. Although in FIG. 2a the sheet-shaped substrate 54 and the lens array 52 are depicted as being discrete elements, these may be integrally molded together.

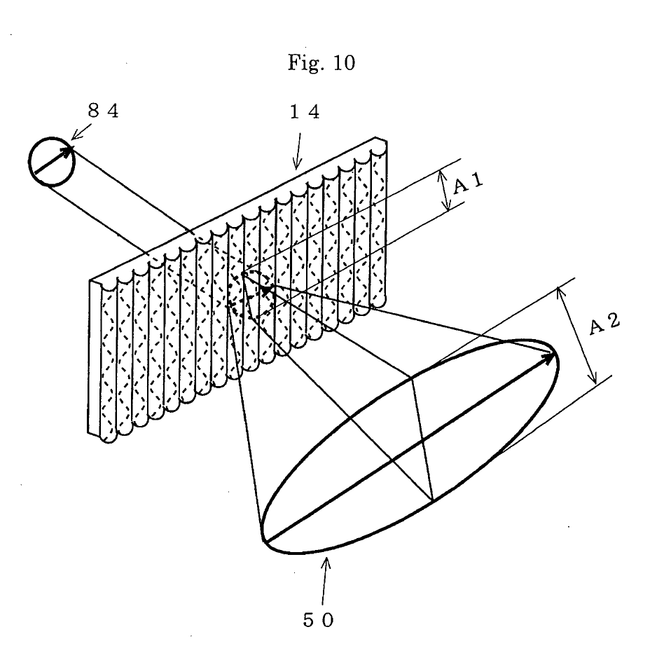

FIG. 10 shows the light-diffusing effect of the light-diffusing sheet 14.

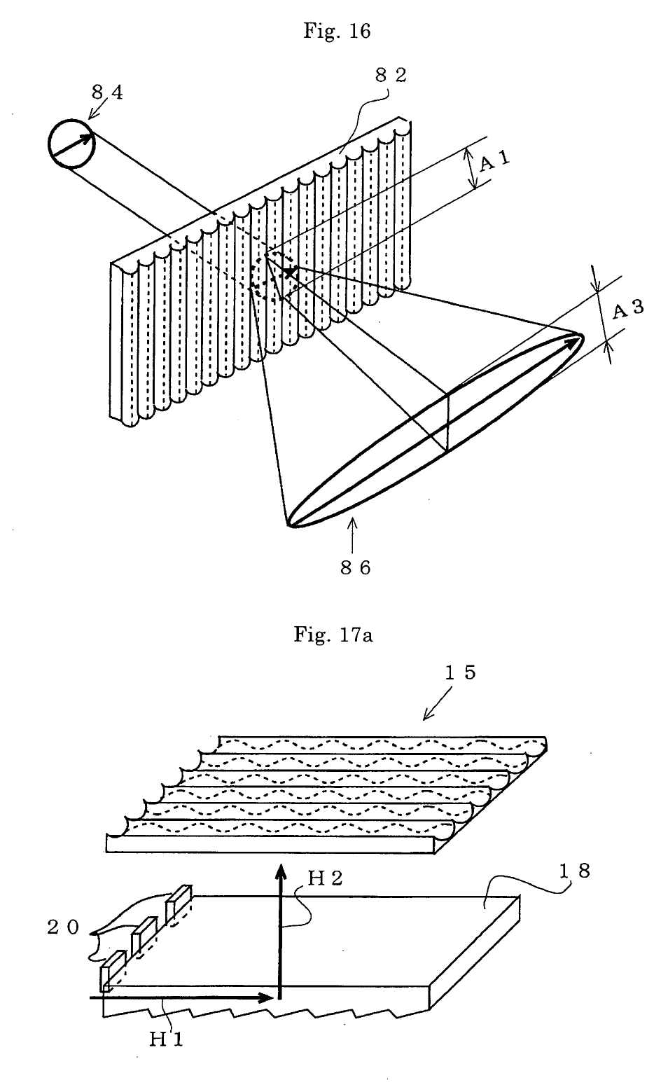

As shown, the light-diffusing sheet 14 diffuses light from a light source 84 in a direction perpendicular to the longitudinal direction of the elongated lens surface in each lens element and also diffuses the light in a direction parallel to the longitudinal direction of the elongated lens surface in each lens element to a considerable extent, as compared with the conventional lenticular lens sheet as shown in FIG. 16.

As shown in FIG. 2b, the elongated lens surfaces of the light-diffusing sheet 14 may have a concavely arcuate cross-section. In this case, the depth of the concavely arcuate lens surfaces is sinusoidally varied in the longitudinal direction thereof, as in the case of the above-described example. This alternative structure also brings about effects similar to the above.

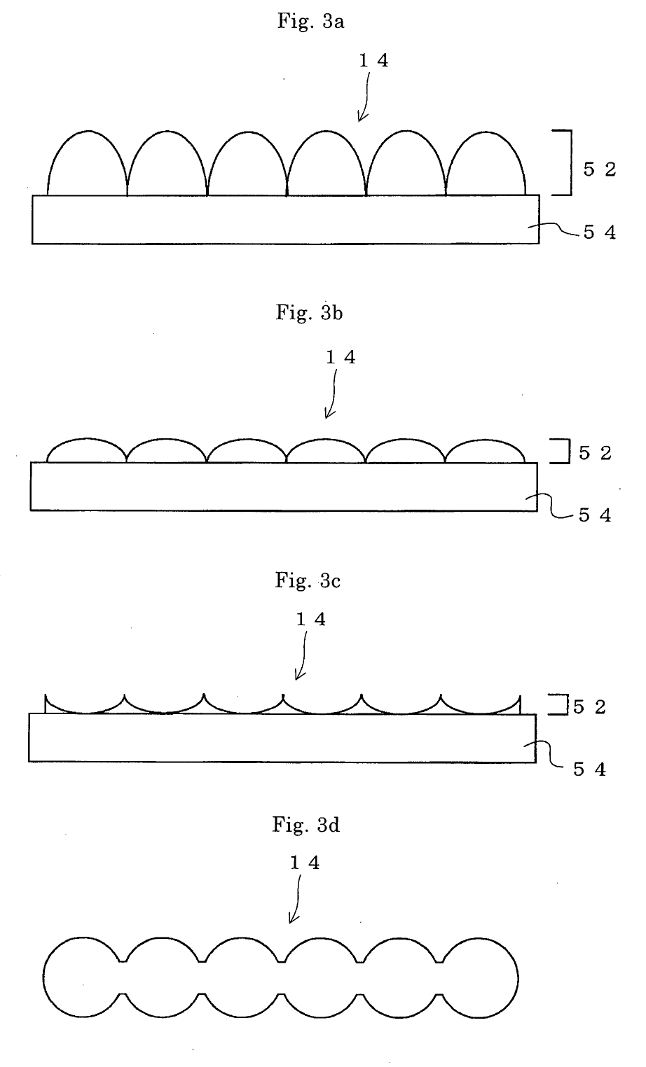

As shown in FIGS. 3a to 3c, the cross-section of the elongated lens surfaces may be appropriately modified in shape and curvature. As shown in FIG. 3d, lens arrays may be provided on both sides of a sheet-shaped substrate.

Parts a to d of FIG. 4 show an example in which elongated lens surfaces are arranged such that the height of each elongated lens surface sinusoidally varies in longitudinal direction thereof with a phase difference of about 120 degrees relative to that of the adjacent elongated lens surfaces.

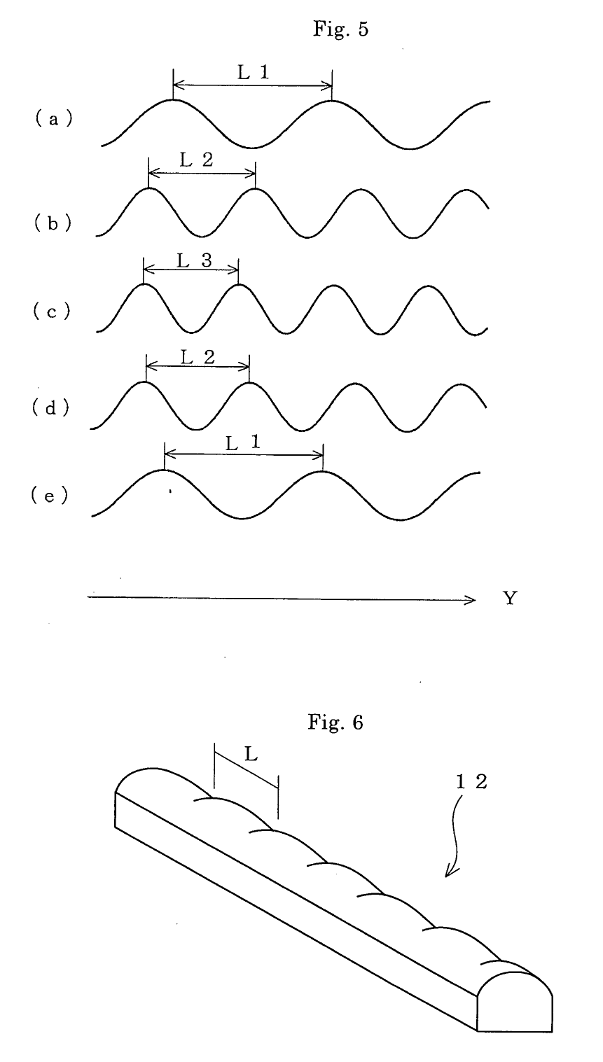

Parts a to e of FIG. 5 show that the pitches of varying height of successive four elongated lens surfaces successively change: L1, L2, L3 and L2, and the change in the pitch is repeated in the other elongated lens surfaces.

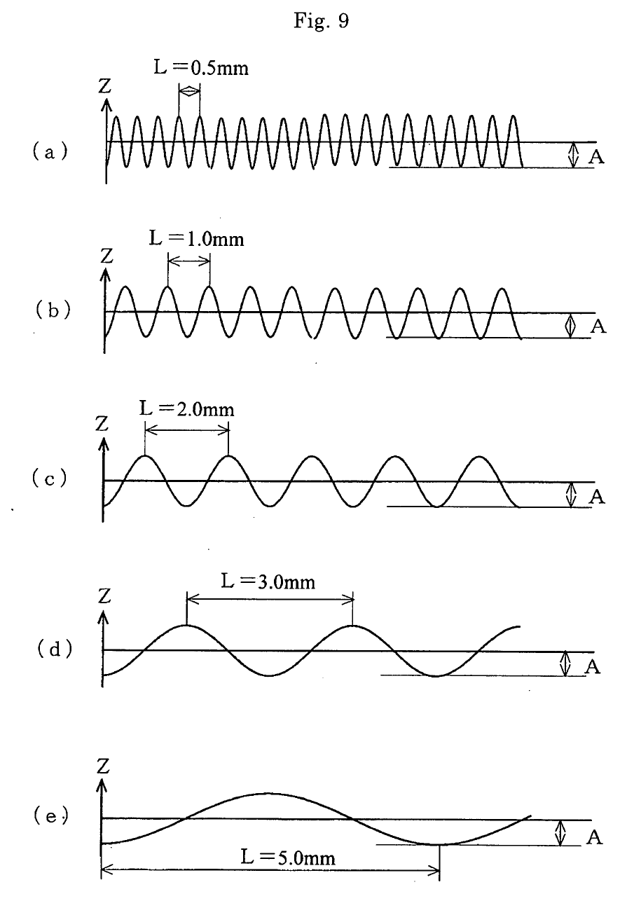

Parts a to e of FIG. 9 show examples of changing the pitch L. Letting the half amplitude be represented by A, the smaller the value of L/A, the higher the light-diffusing effect. The value of L/A may be appropriately determined in the range of 1 to 200. For example, to increase the light-diffusing effect in order to diffuse light so that the light source is imaged as shown in FIG. 10, the value of L/A is preferably determined in the range of 1 to 10. To weaken the light-diffusing effect, the value of L/A is preferably determined in the range of 100 to 200. When the present invention is applied to an edge-light type light guide plate, as will be described below, the value of L/A is preferably determined in the range of 10 to 80.

In the present invention, it is possible to properly combine together the above-described factors, i.e. the pitch in the longitudinal direction of the elongated lens surfaces, phase, concave or convex cross-sectional configuration, curvature thereof, etc. Combining together many of these factors enables the light-emitting surface of the light-diffusing sheet to have a random configuration. The light-emitting surface configuration may be appropriately designed according to the light-diffusing effect required of the light-diffusing sheet.

FIG. 6 shows a single lens element 12 having an elongated lens surface.

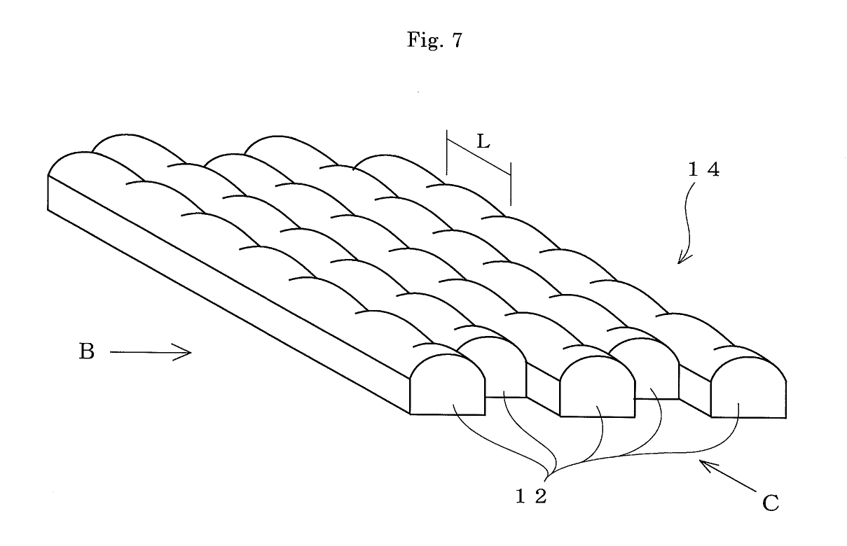

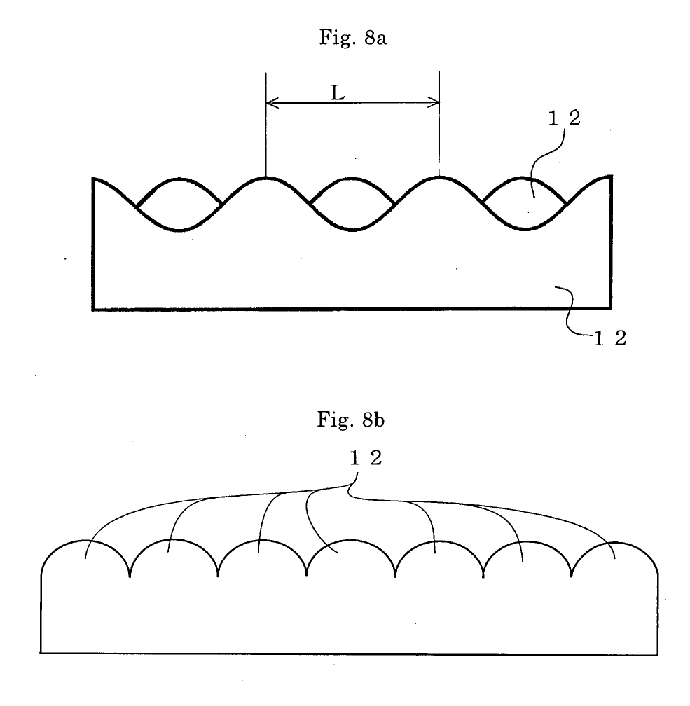

FIG. 7 shows a light-diffusing sheet 14 formed by arranging side-by-side in a row a plurality of elongated lens elements 12 as shown in FIG. 6. FIG. 8a is a side view of the light-diffusing sheet 14 as seen from the direction B in FIG. 7. FIG. 8b is an end view of the light-diffusing sheet 14 as seen from the direction C in FIG. 7.

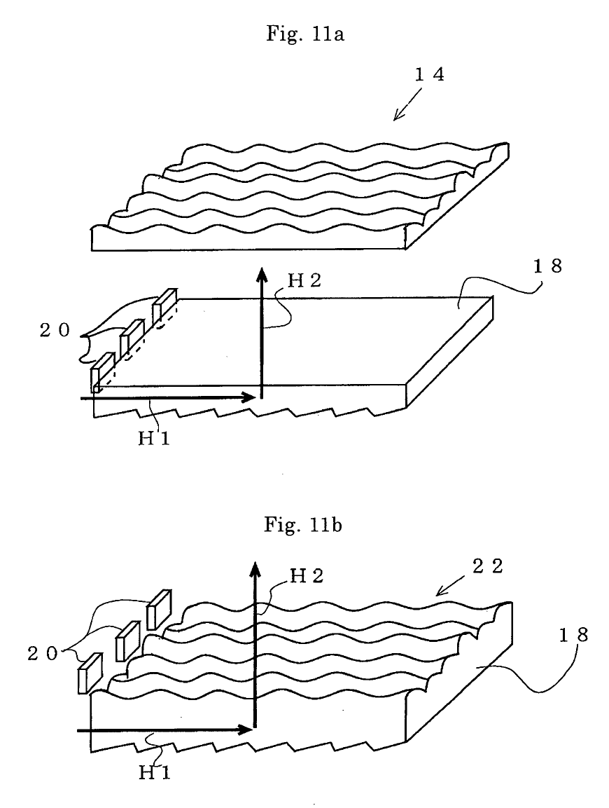

FIG. 11a shows an example in which the light-diffusing sheet 14 is applied to a lighting device having an edge-light type light guide plate 18. In this lighting device, the light guide plate 18 receives light emitted from LED light sources 20 in the direction of the arrow H1 and emits light in the direction of the arrow H2. The light-diffusing sheet 14 is provided at the light-emitting side of the light guide plate 18. With this setting, the light-diffusing sheet 14 can diffuse light from the light guide plate 18 without reducing the amount of light therefrom and provide uniformly distributed illuminating light to a liquid crystal display device (not shown). The light-diffusing sheet 14 may be used in place of the conventional diffusing plate and will be able to improve the light transmission efficiency as compared with the conventional diffusing plate.

FIG. 11b shows an example in which the light-diffusing sheet 14 and the light guide plate 18 are integrally formed by molding polycarbonate or the like. By so doing, cost and thickness reduction can be achieved.

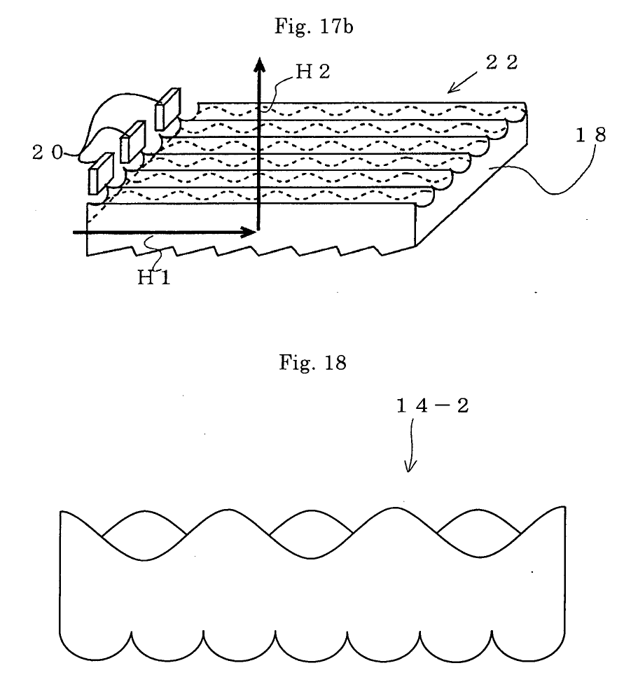

A light-diffusing sheet having elongated lens surfaces with a concave cross-section is also applicable to a lighting device in the same way as the above (see FIGS. 17a and 17b).

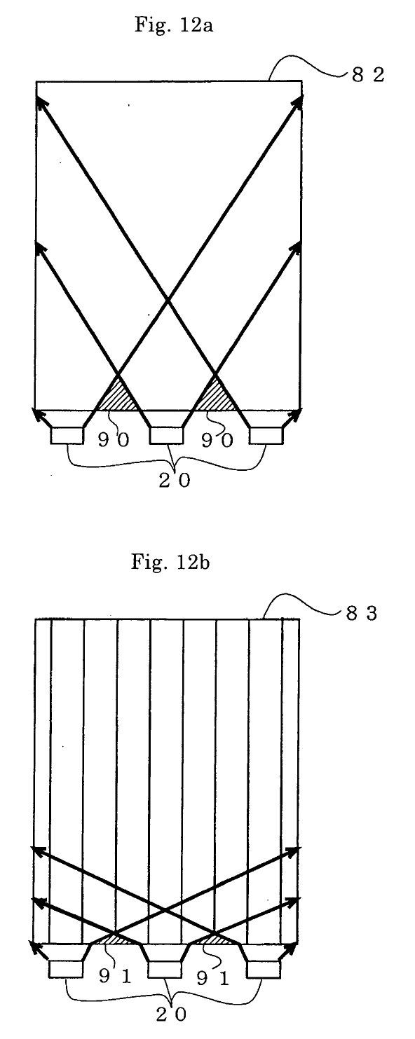

FIGS. 12a and 12b show an advantageous effect in using the light-diffusing sheet in the above-described lighting device.

FIG. 12a shows the light-emitting side surface of a light guide plate 82 integrally formed with a conventional lenticular lens sheet in place of the above-described light-diffusing sheet. In this case, dark areas 90 undesirably occur between the LED light sources 20. FIG. 12b shows the light-emitting side surface of a light guide plate 83 integrally formed with the light-diffusing sheet 14. In this case, dark areas 91 reduce because the light-diffusing sheet 14 provides a large light-diffusing effect in the longitudinal direction of the elongated lens surface in each of the lens segments, as stated above.

FIG. 18 shows a light-diffusing sheet similar to the light-diffusing sheet shown in FIGS. 8a and 8b but different therefrom in that the lens array formed on the upper side of the light-diffusing sheet shown in FIGS. 8a and 8b is formed on both the upper and lower sides thereof in order to further increase the light-diffusing effect. In the illustrated example, the lens surfaces on the upper side and those on the lower side are arranged to extend perpendicular to each other in plan view.

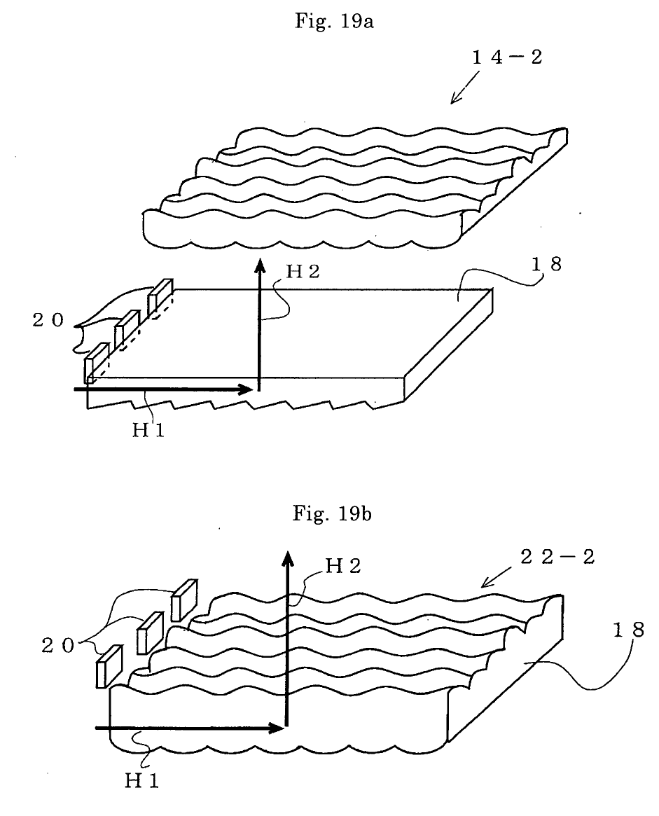

FIG. 19a shows an example in which the light-diffusing sheet shown in FIG. 18 is applied to a lighting device. FIG. 19b shows an example in which the light-diffusing sheet shown in FIG. 18 is used as a light guide plate. With this arrangement, the space occupied by the light guide plate and the light-diffusing sheet can be minimized to reduce the overall thickness of the lighting device, and cost reduction can also be attained.

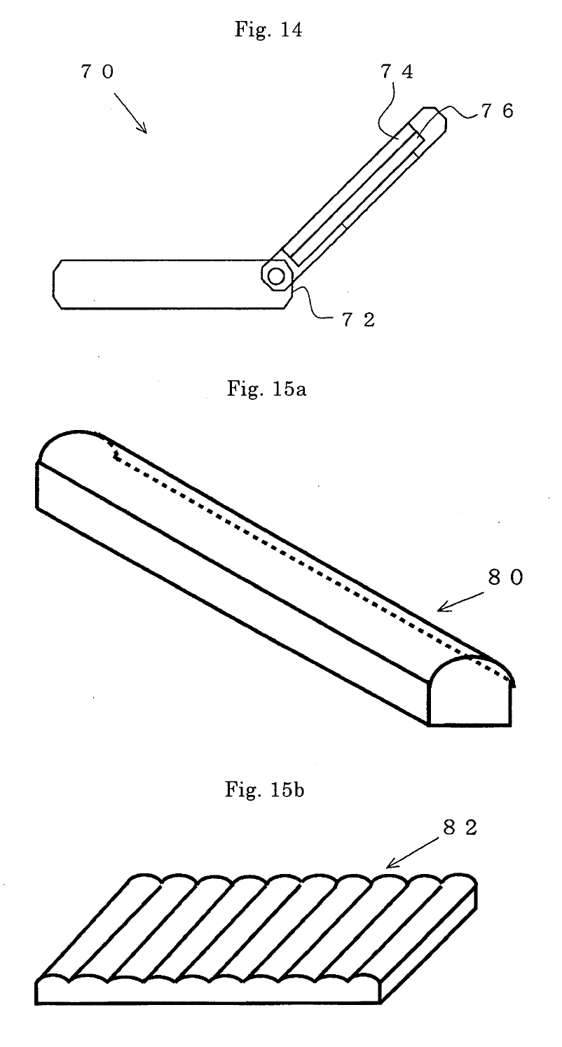

FIG. 14 shows a cellular phone 70 as an example of an apparatus having a liquid crystal display device 74 using a lighting device 76 according to the present invention. An apparatus using the liquid crystal display device according to the present invention can be made less costly and high in light utilization efficiency. The liquid crystal display device according to the present invention is effectively usable not only in small-sized apparatus such as cellular phones but also in relatively large-sized apparatus such as televisions.

It should be noted that the present invention is not necessarily limited to the foregoing embodiments but can be modified in a variety of ways without departing from the gist of the present invention. For example, although in this specification the light-diffusing sheet according to the present invention is shown as being applied to an edge-light type light guide plate, by way of example, the light-diffusing sheet is also applicable to an aligned-light type light guide plate in which a light source is provided on a side of the light guide plate opposite to the side serving as a light emitting surface of the same.

What is claimed is:

1. An optical element having a light-emitting surface that emits light while diffusing it, said light-emitting surface having a plurality of parallel elongated lens surfaces arranged side-by-side in a row thereon, said elongated lens surfaces each having an arcuate cross-section, wherein a height of said arcuate cross-section of said elongated lens surfaces varies continuously and repeatedly in a longitudinal direction of said elongated lens surfaces.

2. An optical element according to claim 1, wherein the height of the cross-section of each of said elongated lens surfaces varies sinusoidally in the longitudinal direction of said lens surface.

3. An optical element according to claim 2, wherein sinusoidal waves formed by each adjacent pair of said elongated lens surfaces differ from each other in at least one of phase, period, and amplitude.

4. An optical element according to claim 3, which has an opposite surface opposite to said light-emitting surface and has a sheet shape as a whole.

5. An optical element according to claim 4, wherein said opposite surface has a plurality of parallel second elongated lens surfaces arranged side-by-side in a row on said opposite surface, said second elongated lens surfaces each having an arcuate cross-section and extending in a direction perpendicular to the longitudinal direction of the elongated lens surfaces on said light-emitting surface, wherein a height of said arcuate cross-section of said second elongated lens surfaces varies continuously and repeatedly in a longitudinal direction of said second elongated lens surfaces.

6. An optical element according to any of claim 1, wherein the cross-section of each of said elongated lens surfaces is convexly or concavely arcuate.

7. A lighting device using the optical element according to claim 1.

8. A lighting device according to claim 7, which has a light guide plate having a light-emitting surface, wherein said optical element is disposed to oppose to the light-emitting surface of said light guide plate in parallel thereto.

9. A lighting device according to claim 8, wherein said light guide plate and said optical element are integrally molded together.

10. A liquid crystal display device having the lighting device according to claim 9.

11. An apparatus having the liquid crystal display device according to claim 10.
